(19) United States
(12) Patent Application Publication
(10) Pub. No.: US 2005/0174065 A1
(43) Pub. Date: Aug. 11, 2005

(54) LED light strings

(75) Inventor: John Louis Janning, Dayton, OH (US)

Correspondence Address: Robert L. Clark, STE 210, 3033 South Kettering Boulevard, Dayton, OH, 45439, US

(73) Assignee: JIJ, Inc., Dayton, OH (US)

(21) Appl. No.: 11/124,459

(22) Filed: May 6, 2005

Related U.S. Application Data
(60) Provisional application No. 60/670,197, filed on Apr. 11, 2005.
(60) Provisional application No. 60/670,797, filed on Apr. 13, 2005.
(60) Provisional application No. 60/671,639, filed on Apr. 15, 2005.
(60) Provisional application No. 60/674,990, filed on Apr. 26, 2005.

(51) Int. Cl. H05B 39/00

(52) U.S. Cl. 315/185 S; 315/185 R

(57) ABSTRACT

Light emitting diode (LED) lights are mixed with incandescent lights in a light string, e.g., for Christmas or other holiday season lighting. In an incandescent light string, such as a mini-light string, in which the incandescent lights are wired in series, LED lights are wired in parallel in one or more groups which are in turn wired in series with incandescent lights in described light string circuits. The LED lights may be provided in the form of an add-on LED light string, or “piggy-back” light string, that for its power supply connects with an empty bulb socket in an incandescent light string. An incandescent flasher bulb may be incorporated into the LED light string to provide surge protection as well as to enable flashing or twinkling of the LED lights. Surge protection may also be provided by an electrical shunt, e.g., a semiconductor shunt, incorporated into the LED light string, or incorporated with the associated empty bulb socket as part of the incandescent light string.

### CROSS-REFERENCE TO RELATED APPLICATIONS

Benefit of priority is claimed based on U.S. Provisional Application No. 60/670,197 filed Apr. 11, 2005; U.S. Provisional Application No. 60/670,797 filed Apr. 13, 2005; U.S. Provisional Application No. 60/671,639 filed Apr. 15, 2005; and U.S. Provisional Application No. 60/674,990 filed Apr. 26, 2005.

### BACKGROUND

Incandescent light strings are commonly used for Christmas or other holiday season lighting. Examples are standard 120 VAC incandescent light strings, as well as Stay Lit® mini-light strings that contain a semiconductor shunt in each socket. (The shunt in Stay Lit® bulb sockets allows series wired mini-lights to stay on even though some mini-lights are either inoperative or are missing from their respective sockets.)

When adding additional bulbs to a series wired string a major manufacturing expense is the cost of wire. Standard practice is to use three lines, two for powering the lights in the string plus a return line for its terminal female receptacle. This is in contrast to parallel wired strings for which only two lines are required. LED lights and mini-lights are normally series wired due to their low voltage requirements per light. However it would be desirable to take advantage of the lower cost of parallel wiring.

In order to extend an existing light string to include added lights, a common practice is to connect light strings end to end using male and female plug type terminating connectors that light strings typically incorporate. Connecting two strings together generally results in power and current requirements double that for a single string alone. It may also result in having to add more lights than actually desired, e.g., if the desired number of additional lights is less than the number of lights in the available add-on string. Connecting two strings together also places all of the added light at the end of the string, as opposed to other locations along the string length that might be more ideal, such as to achieve a particular pattern of lights. Greater flexibility in adding specific numbers of extra lights in specific light string positions, while minimizing current and power required, may be desired.

One feature sometimes desired in a light string is that of flashing or twinkling lights. A common way to implement this in an incandescent string is to add an incandescent flasher bulb to a standard light string, or one or more incandescent flasher bulbs in a shunted, e.g., Stay Lit® mini-light, type light string. In a standard series wired light string adding a single flasher bulb causes all bulbs in the string to flash. In a Stay Lit® mini-light string only the flasher bulb will flash due to string current being diverted through the associated shunt when the flasher bulb turns off. For multiple bulbs to flash in a Stay Lit® mini-light string it is required to have a flasher bulb in multiple sockets. In certain applications, however, it may be desired to have more variation in the number of lights that will flash in response to a flasher bulb being added.

### SUMMARY

Light emitting diode (LED) lights are mixed with incandescent lights in a light string, e.g., for Christmas or other holiday season lighting. In an incandescent light string, such as a mini-light string, in which the incandescent lights are wired in series, LED lights are wired in parallel in one or more groups which are in turn wired in series with incandescent lights in described light string circuits. The LED lights may be provided in the form of an add-on LED light string, or “piggy-back” light string, that for its power supply connects with an empty bulb socket in an incandescent light string. An incandescent flasher bulb may be incorporated into the LED light string to provide surge protection as well as to enable flashing or twinkling of the LED lights. Surge protection may also be provided by an electrical shunt, e.g., a semiconductor shunt, incorporated into the LED light string, or incorporated with the associated empty bulb socket as part of the incandescent light string.

Other features and advantages will become apparent from the drawings, the further description of examples and the claims to follow.

### DRAWING DESCRIPTION

FIG. 1 shows a schematic AC operated series-parallel combination light string circuit with parallel-wired LED lights and series-wired incandescent lights.

FIG. 2 shows a schematic DC operated series-parallel combination light string circuit with parallel-wired LED lights and series-wired incandescent lights.

FIG. 3 shows a schematic add-on LED light string connected to an empty bulb socket of an AC operated series-wired incandescent light string.

FIG. 4 shows a schematic DC operated series-parallel combination light string circuit with single Zener diode lighting element protective shunts.

FIG. 5 shows a schematic add-on LED light string with parallel-wired LED lights, series resistors and an optional back-to-back Zener diode shunt.

FIG. 6 shows a schematic add-on LED light string with parallel-wired LED lights, a back-to-back Zener diode shunt, and an incandescent flasher bulb, with series-wired pairs of LED lights connected in parallel.

FIG. 7 shows a variant schematic add-on LED light string with parallel-wired LED lights, a back-to-back Zener diode shunt, and incandescent flasher bulb.

FIG. 8 shows a schematic add-on LED light string with parallel-wired LED lights, a back-to-back Zener diode shunt, and incandescent flasher bulb, with series-wired pairs of LED lights connected in parallel.

FIG. 9 shows a variant schematic add-on LED light string with parallel-wired LED lights, a back-to-back Zener diode shunt, and incandescent flasher bulb, with series-wired resistors and LED lights connected in parallel.

### DETAILED DESCRIPTION

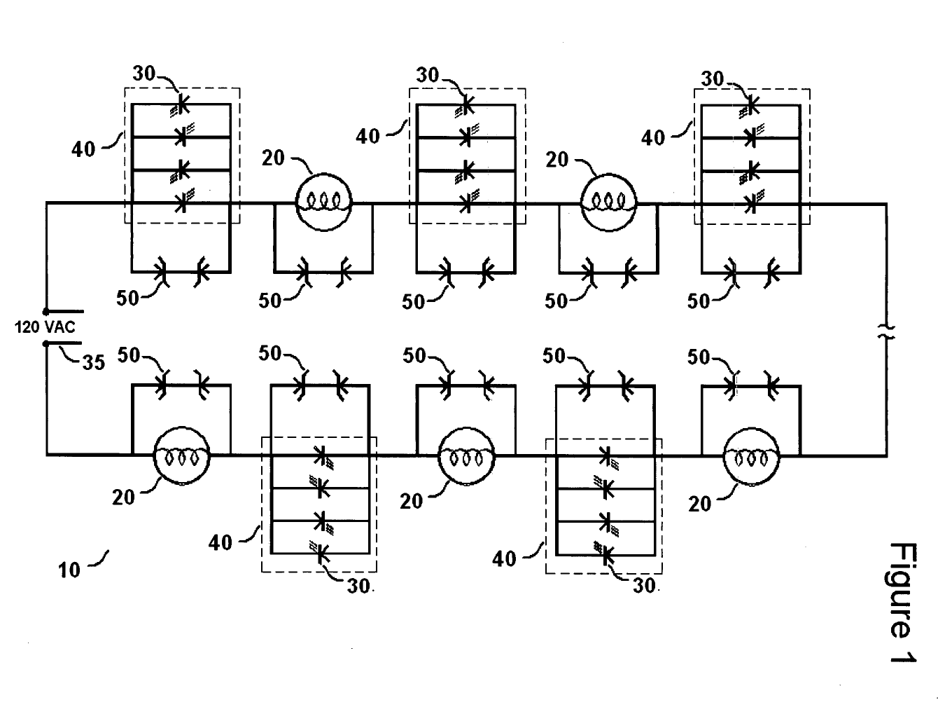

FIG. 1 illustrates an exemplary light string 10 in which incandescent lights 20 are connected in series, and LED lights 30 are connected in parallel in a series-parallel combination type circuit. The LED lights 30 are wired in parallel in groups 40 which are in turn wired in series with incandescent lights 20 in the light string 10. Incandescent lights 20 and LED lights 30 are powered by a U.S. standard 120 VAC electrical input through a conventional wall plug 35. The incandescent lights 20 may be any available low voltage incandescent lights, such as standard 2.5V low voltage mini-lights, e.g., 2.5V/170-200 ma mini-lights used in Stay-Lit® type light strings. The LED lights 30 may be LED lights, such as 2-3.5V/20 ma rated LED lights.

FIG. 1 illustrates optional electrical shunts 50 associated with each incandescent light 20, e.g., a back-to-back or counter-connected Zener diodes, as taught in my U.S. Pat. No. 6,580,182 and used in a Stay Lit® type mini-light string. The shunt 50 connected, e.g., across the socket of each incandescent light 20, allows the incandescent lights 20 and the parallel-wired LED lights 30 to stay on even though some incandescent lights 20 may become inoperative or are missing from their respective sockets. As taught in my U.S. Pat. No. 6,765,313 the shunt 50 could be a single Zener diode, or it could be a diode array as taught in my U.S. Pat. No. 6,084,357, or a half diode array, or it could be a varistor as taught in U.S. Pat. No. 3,912,966 to Harnden or other shunt. In Stay-Lit® type 50 or 100 mini-light strings, the preferred shunt 50 across each incandescent light socket is two 1N4728A Zener diodes connected back-to-back.

FIG. 1 also shows the use of the shunts 50 associated with each group 40 of parallel connected LED lights 30. This use of the electrical shunts 50 is also optional. However the associated shunts 50 may be helpful to regulate the voltage across the LED lights 30 and to suppress surges from inrush current when the light string 10 is first turned on. Such surges, originating as a result of initial low resistances of incandescent lights 20 when cold, may or may not be an issue, depending upon the characteristics and quality of the LED lights 30 and other elements in the light string circuit with them. When the incandescent lights 20 are turned on their resistances rise as their filaments warm and inrush current surges to the LED lights 30 would generally then be of less concern. A negative temperature thermistor (NTC) in the string 10 could also protect against current surges.

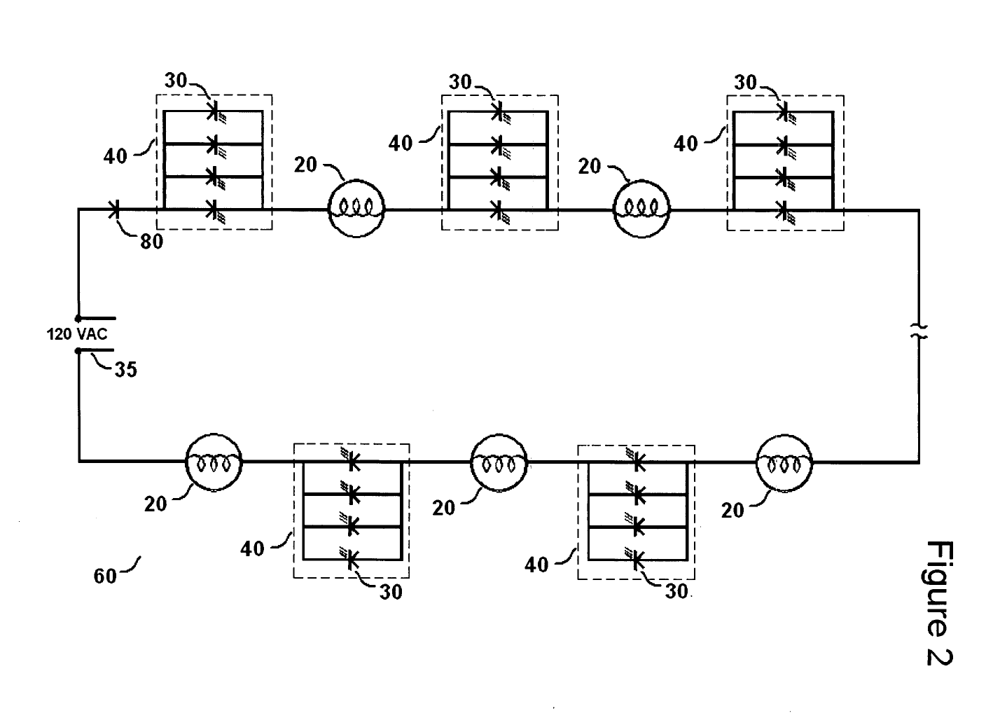

As shown in FIG. 1 the LED lights 30 are preferably arranged with alternating forward current directions or polarities. This is to enable half of the LED lights 30 to be on at a time during each half of the input AC power cycle. By alternating the polarities it also makes it possible to remove two LED lights 30 at a time if desired from the light string 10 while leaving a balanced polarity distribution of LED light 30 remaining on the string 10. However in other light strings such as light string 60 illustrated in FIG. 2 the incandescent lights 20 and the LED lights 30 may be DC powered, such as when a rectifier diode 80 is used with a 120 VAC power input as shown, or, e.g., by using a bridge rectifier. In that case the polarity orientations of the LED lights 30 would generally each be the same to enable all LED lights 30 to be on at once. Also if a single Zener diode were used for the shunts 50 in the light string 10 shown in FIG. 1, the LED lights 30 would be effectively DC powered and uniform polarity orientations of the LED lights 30 would similarly be used in that case.

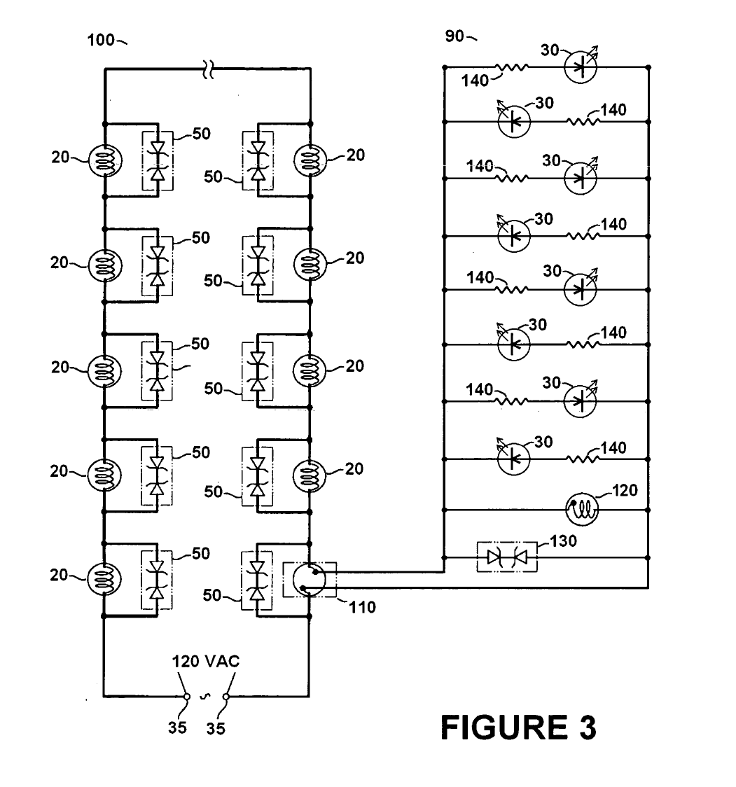

FIG. 3 illustrates an add-on or “piggy-back” type light string 90 that attaches to an incandescent light string 100 by a power supply connection provision or connector 110 that engages and draws power from an empty bulb socket in the light string 100. The connector 110, e.g., may be a male plug that inserts into the socket in the light string 100. As shown, each incandescent bulb 20 in the light string 100 has an electrical shunt 50 across the socket of each incandescent bulb 20 position. The electrical shunt 50, which may be back-to-back Zener diodes, a single Zener diode, a diode array, half diode array, varistor or other shunt as previously discussed, would normally be present if light string 100 is a Stay-Lit® type shunted light string. However the add-on light string 90 is not limited for use with shunted incandescent light strings and thus shunts 50 may not be present in a given case where the light string 100 may happen to be an unshunted string.

An optional feature of the add-on light string 90 shown in FIG. 3 is an incandescent flasher bulb 120 connected across the connection provision or connector 110. In addition to providing random twinkling of the LED lights 30 in time with its flashing circuit, the incandescent flasher bulb 120 provides added surge protection to the LED lights 30 from inrush current protection. Such protection by the incandescent flasher bulb 120 may be desired particularly when a shunt, thermistor or other element that can serve that function is absent. As previously discussed, inrush current surges may not be an issue in any event, e.g., depending upon the characteristics and quality of the LED lights 30 used in the light string 90.

A beneficial feature of the incandescent flasher bulb 120 in the add-on LED light string 90 is that, when combined with the incandescent light string 100, the incandescent flasher bulb 120 selectively produces random flashing or twinkling of multiple other bulbs (LED lights 30), but less than all lights in the overall circuit. As previously mentioned, a single flasher bulb causes all lights to flash in an unshunted series light string, or only the flasher bulb to flash in a Stay Stay-Lit® type shunted light string. Another beneficial feature of the incandescent flasher bulb 120 is the availability of three state flashing, where the LED lights 30 are off, dim or full bright and where each of these states may have a different duration.

When a standard flasher bulb 120 warms, its light goes off due to an internal bi-metallic strip, and the LED lights 30 will come on bright. While only four of the illustrated LED lights 30 are actually on at any one time in an AC powered circuit, all eight LED lights 30 would be visually seen as being on in a 60 cycle AC circuit. When the flasher bulb 120 cools enough to come on again, the LED lights 30 may at first go off momentarily until the flasher bulb resistance increases sufficiently. As the voltage drop across the flasher bulb 120 increases, the LED lights 30 will come on dim until the flasher bulb 120 goes off again—at which time the LED lights 30 will again brighten and be fully on. Of course, different LED lights may respond differently to different voltages that may be applied by operation of the flasher bulb 120.

As further shown in FIG. 3, the exemplary add-on LED light string 90 has an optional shunt 130 in the form of back-to-back Zener diodes in this example. The other types of shunts useful for the shunt 50 can be used for the shunt 130. The back-to-back Zener diodes used for the shunt 130 in the add-on LED light string 90 would preferably be 1N4730A type Zener diodes which have slightly higher regulated voltage levels that the 1N4728A Zener diodes used in standard Stay-Lit® strings. The higher voltage Zener diodes may be helpful to regulate higher voltage LED lights 30 if used in the light string 90.

The shunt 130 may be useful in the absence of a similarly functioning electrical shunt 50 in the connecting socket of the target incandescent light string 100, or a negative temperature thermistor or similar element in the light string 100 protecting the LED lights 30 in the add-on string 90 from inrush current surges, or an incandescent flasher bulb 120 which would provide surge protection. The shunt 130 could be added to the add-on string 90 as insurance against the possibility that an associated shunt 50 would not be present in the light string 100 and that an incandescent flasher bulb 120 would not be present or operative in the light string 90. There would be no particular disadvantage, except perhaps cost, if two or more of the shunt 50, the shunt 130 and the incandescent flasher bulb 120 all happened to be present in a given implementation.

The shunt 130 in the add-on LED light string 90 regulates the voltage that may appear across the LED lights 30. An associated shunt 50 in light string 100 across the LED lights 30 performs this function also. Such voltage regulation may be helpful particularly to facilitate the ability to remove or otherwise reduce the number of LED lights 30 which would increase the total resistance across the remaining LED lights 30 due to their parallel connections. The shunt 50 or 130 would limit total current through LED lights 30 if needed to limit voltage drop to the regulated level. Whether or not it is particularly beneficial to regulate the voltage across the LED lights 30 with a shunt 50 and/or a shunt 130 would depend upon the number, quality and characteristics of the LED lights 30 being used, the other components in the circuits and the requirements of the user for the numbers of LED lights 30 to keep in place.

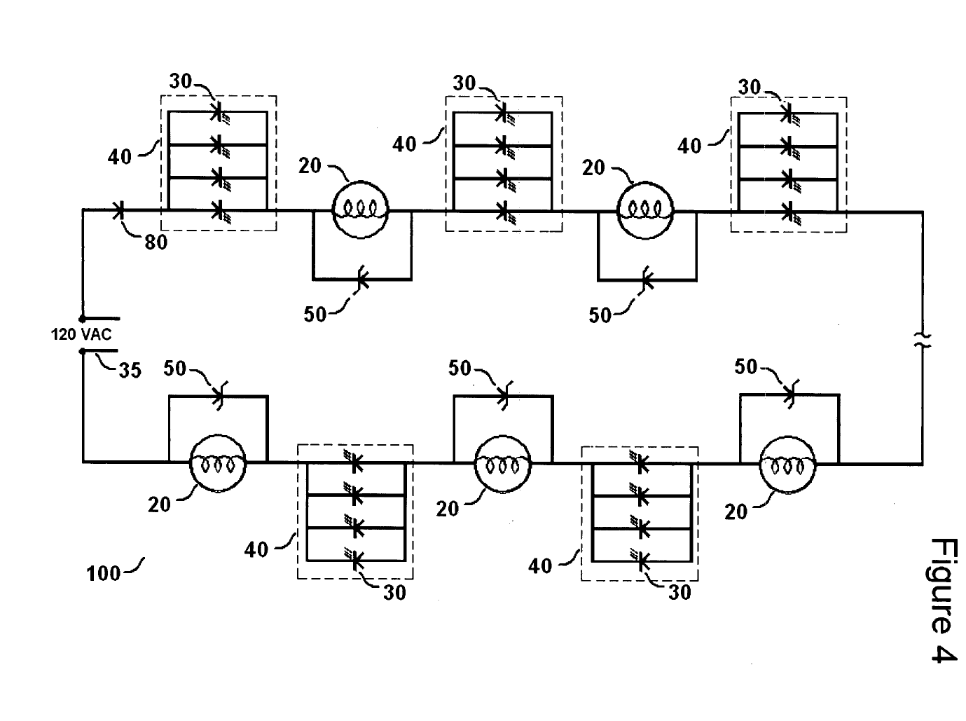

As shown in FIG. 3 the LED lights 30 are preferably arranged with alternating forward current directions or polarities. This is to enable half of the LED lights 30 to be on at a time during each half of the input AC power cycle. By alternating the polarities it also makes it possible to remove two LED lights 30 at a time if desired from the light string 90 while leaving a balanced polarity distribution of LED light 30 remaining on the string 90, as was the case in the light string 10 shown in FIG. 1. However if the target incandescent light string 100 were a DC powered light string, or if a single Zener diode were used for an associated shunt 50 in light string 100 (as shown in FIG. 4) or for a shunt 130 in light string 90, the polarity orientations of the LED lights 30 would generally each be configured in the same direction.

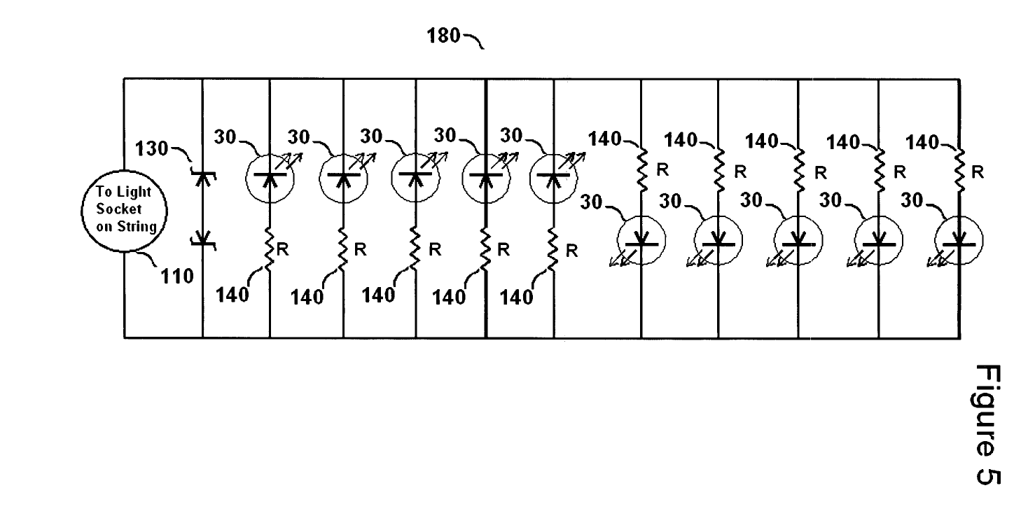

In the exemplary light strings 10, 60 and 90 shown in FIGS. 1, 2 and 3 it may be desirable to optionally incorporate resistors in series with the parallel connected LED lights 30, to limit current through the LED lights 30. Use of series resistors 140 having a resistance value R in an add-on LED light strings 90 and 160 is shown in FIGS. 3 and 5. Resistors 140 could similarly be used in series with the LED lights 30 in the illustrated light strings 10, 60 and 90. Depending upon characteristics and quality of the LED lights 30 and power supply impedance, the voltage drop across an LED light 30 could inhibit another parallel-wired LED light 30 from turning on if its turn on voltage were higher. This might be the case where the voltage requirements differ for LED lights 30 of different colors. A series resistor 140 prevents this from happening. Series resistors 140 can also help minimize LED light output variances as the resistance value of the resistors increases. As resistance value of the resistors 140 increases it obviously decreases power consumption and can potentially limit current through the associated incandescent lights 20 which may be a disadvantage.

Other considerations may also affect the resistance R values for resistors 140 where optionally used in series with the LED lights 30. For example keeping in mind that it is preferable to avoid exceeding the rated reverse breakdown voltage for an LED light 30 (for which there may be greater leeway in the case of higher quality LEDs), the total voltage drop across any LED 30 and its series resistor 140 should be kept less than the reverse breakdown voltage for the oppositely directed, parallel connected LED lights 30. If a shunt 50 or shunt 130 or an incandescent flasher bulb 120 is used in the circuits larger resistance values R can be used for the resistors 140 because these devices will limit the voltages and total current across the LED light 30 and resistor 140 series elements. Otherwise it may be necessary to optimize the resistance R values empirically to take into account the applicable parameters. An exemplary value for the resistance R might be on the order of ten or more ohms in combination with 10 standard 2V/20 ma LED lights 30 in a series-parallel combination circuit with series-connected 2.5V/170-200 ma incandescent lights 20.

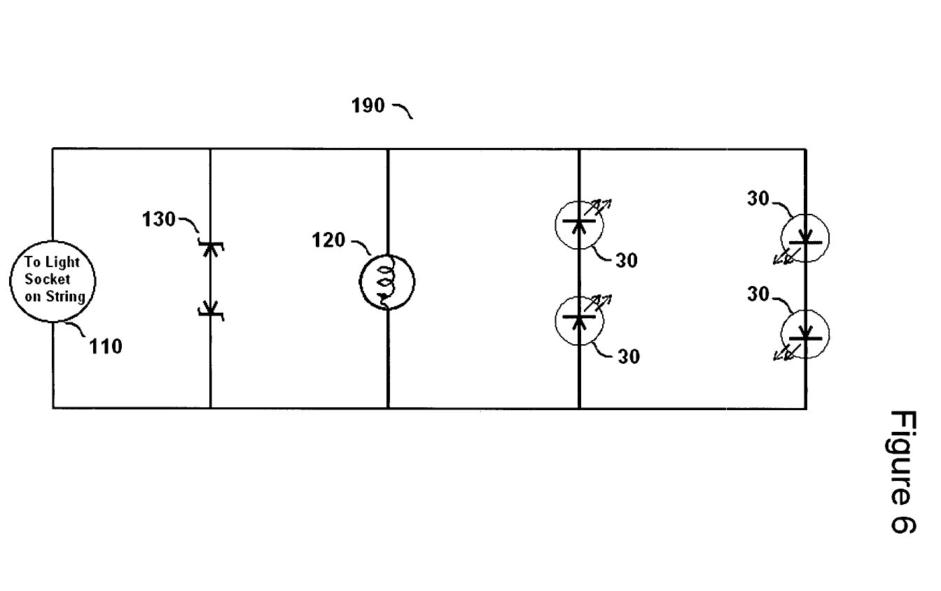

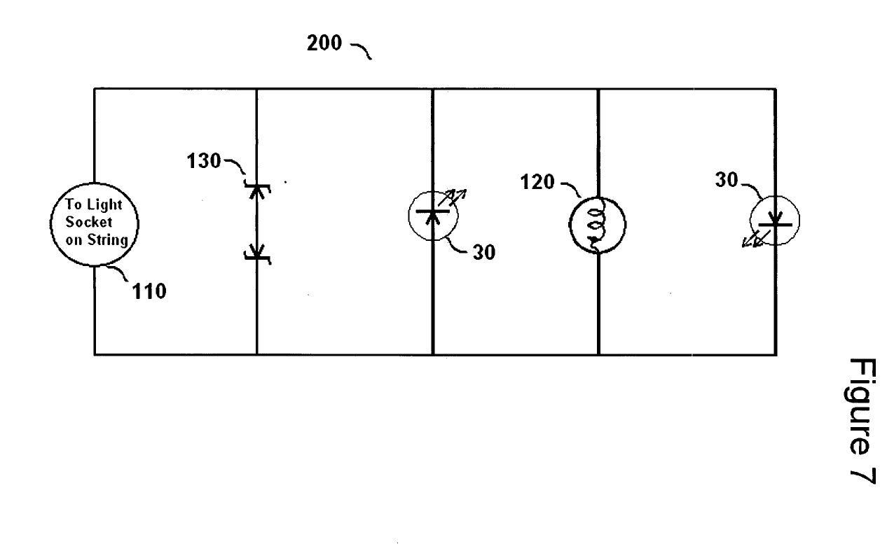

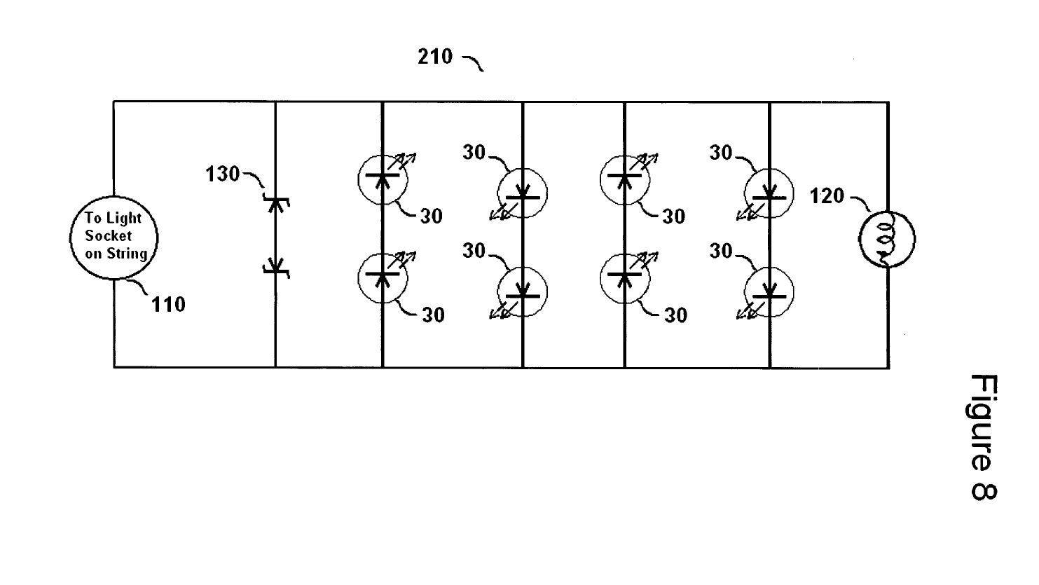

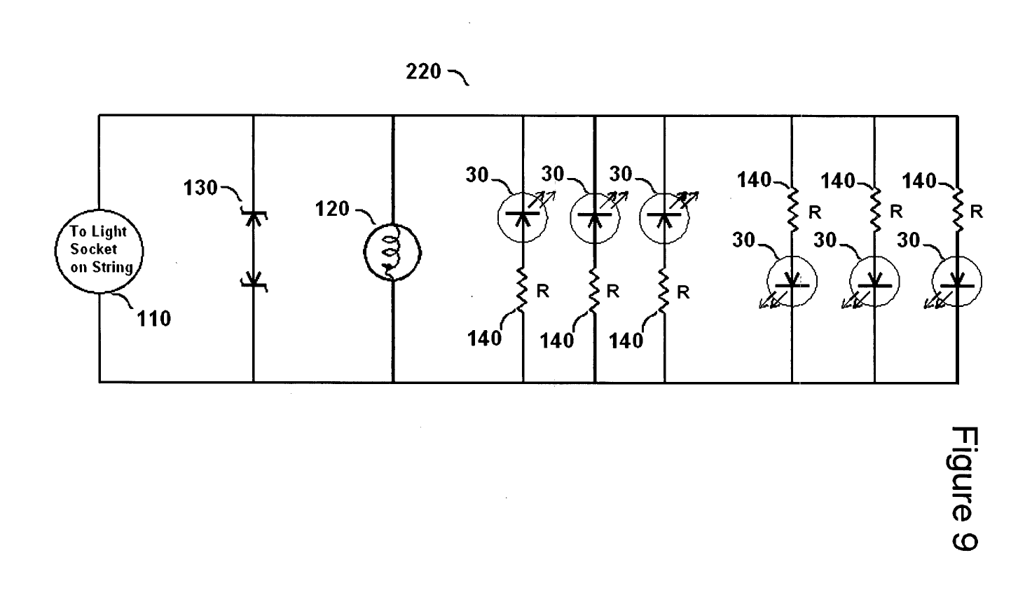

FIGS. 5, 6, 7, 8 and 9 of the drawings schematically illustrate various numbers and polarity orientations of LED lights 30 in different add-on LED light strings 180, 190, 200, 210 and 220 depicted. The optimum number of LED lights 30 to incorporate in an add-on light string or a parallel-connected group 40 in the light strings depicted in FIGS. 1-9 will vary according to the characteristics and quality of the LED lights 30 and the incandescent lights 20, the various elements used in the circuits and the design considerations of the user. The number of LED lights 30 to connect together in parallel might for example be as few as two or as many as twenty or more. If for example it were desired to substitute parallel-connected 2V/20 ma LED lights 30 for a 2.5V/170-200 ma mini-light type incandescent light 20 with no increase in power consumption, ten such LED lights 30 as shown in the preferred add-on light string shown in FIG. 5 could meet that goal. It would then be important to limit the resistance of the add-on string or LED light group 40 to the normal resistance of an incandescent light 20 to maintain the level power consumption desired. Of course fewer than ten LED lights 30 might be used particularly if the user desired to limit or trim the number of LED lights 30 in the add-on string or group 40 to achieve a particular lighting pattern.

Advantages and benefits of the add-on and primary light strings with parallel lights LED lights 30 depicted in FIGS. 1-9 are several. These light string configurations generally provide a way of increasing the number of lighting elements in a light string by enabling substitution of multiple LED lights 30 for an incandescent light 20 in a series incandescent light string. In particular the number of lighting elements may be increased significantly without increasing power consumption if desired. The configurations further permit more lighting elements per light string, if desired, than would be feasible with conventional low voltage series connected low voltage LED or incandescent type light stings. Importantly the depicted configurations also provide a way of increasing the number of low voltage lighting elements in a light string while conserving wiring requirements, due to less wire being required for parallel wired connections versus series wired connections where end to end plugs are used.

The add-on and primary light strings with parallel LED lights 30 depicted in FIGS. 1-9 further permit extensions of series light strings from different locations along the light string length than just at one end as would be the case when two light strings are connected together end to end. For example multiple LED light 30 add-on light strings as disclosed could be added at various points in empty bulb sockets in series strings of incandescent lights 20, or various groups 40 of parallel connected LED lights 30 could be added at various location points in series-parallel combination circuits with series connected incandescent lights 20. This flexibility also allows the lengths of the add-on light strings and groups 40 of parallel connected LED lights 30 to be fixed or trimmed to create lighting patterns, such as icicle, candelabra, snowman or star patterns with LED lights 30 at the pattern's defining nodal points. The parallel-connected LED lights 30 may be configured as protruding “pig-tails” that might be conveniently shortened or trimmed by the user to achieve a custom lighting pattern. Series-connected strings with terminal plugs at each end cannot generally be shortened in this fashion. Providing parallel-connected LED lights 30 with alternating polarity orientations makes it possible for users to shorten the parallel-connected element groups while maintaining a relative balance of LED light 30 polarity orientations in the affected AC powered light string circuits.

The invention can be carried out as described in examples above and in many other embodiments not specifically described here. A very wide variety of embodiments are thus possible and are also within the scope of the following claims.

1. A series-parallel combination circuit in which incandescent lights are connected in series in a light string and LED lights are connected in parallel.

2. The circuit of claim 1 in which said LED lights are connected in the form of multiple parallel groups of said LED lights to form a specific pattern of lights.

3. The circuit of claim 2 in which said pattern is an icicle, candelabra, snowman or star pattern of lighting elements, with an LED light at each nodal point of the pattern.

4. The circuit of claim 2 in which said pattern is formed by multiple add-on strings of various lengths of parallel-connected LED lights connected to a string of series-connected incandescent lights.

5. The circuit of claim 1 in which at least a group of said LED lights connects to said light string by a power supply connection in series with said incandescent lights.

6. The circuit of claim 5 in which said power supply connection engages and draws electrical power from an empty incandescent bulb socket in said light string.

7. The circuit of claim 5 in which an incandescent flasher bulb is connected across said power supply connection.

8. The circuit of claim 5 in which an electrical shunt is connected across said power supply connection.

9. The circuit of claim 8 in which an incandescent flasher bulb is connected across said power supply connection.

10. The circuit of claim 1 in which incandescent lights are AC powered and LED lights are connected in parallel with alternating polarities.

11. The circuit of claim 1 in which incandescent lights are DC powered and LED lights are connected in parallel with in the same polarity direction.

12. An LED light string having a power supply connector adapted to engage and draw electrical power from an empty bulb socket in an incandescent light string.

13. The LED light string of claim 12 further comprising at least one LED light electrically connected across said connector.

14. The LED light string of claim 13 further comprising a resistor electrically connected in series with said LED light.

15. The LED light string of claim 12 in which multiple LED lights are electrically connected in parallel across said connector with alternating connection polarities.

16. The LED light string of claim 12 in which a pair of LED lights is electrically connected in series across said power supply connector.

17. The LED light string of claim 12 having multiple pairs of LED lights electrically connected in parallel across said connector with alternating connection polarities, each pair of LED lights being electrically connected in series.

18. The LED light string of claim 12 in which an incandescent flasher bulb is electrically connected across said power supply connector in the LED light string.

19. The LED light string of claim 19 having a shunt electrically connected across said power supply connector in parallel with said incandescent flasher bulb.

20. The LED light string of claim 12 having a shunt electrically connected across said power supply connector in the LED light string.

21. The LED light string of claim 20 in which said shunt comprises back-to-back Zener diodes.

22. The LED light string of claim 20 in which said shunt comprises a single Zener diode.

23. The LED light string of claim 20 in which said shunt comprises a varistor.

24. The LED light string of claim 20 having an incandescent flasher bulb electrically connected across said power supply connector.

25. An LED light string having an incandescent flasher bulb electrically connected in parallel with one or more LED lights.

26. An LED light string having a semiconductor shunt electrically connected in parallel with one or more LED lights.

27. Light string circuits, comprising:
a string of incandescent lights, including bulb sockets electrically connected in series, at least one of said bulb sockets being occupied by an incandescent light bulb;
a piggy-back light string, including a power supply connector engaged in one of said bulb sockets, and at least one LED light electrically connected across said connector.

28. The circuits of claim 27 in which said piggy-back light string includes a resistor electrically connected in series with said LED light.

29. The circuits of claim 27 further comprising an electrical shunt connected across the bulb socket in which said connector is engaged.

30. The circuits of claim 29 in which said shunt comprises back-to-back Zener diodes.

31. The circuits of claim 29 in which said shunt comprises a single Zener diode.

32. The circuits of claim 29 in which said shunt comprises a varistor.

33. The circuits of claim 29 having an incandescent flasher bulb electrically connected across said power supply connector.

34. The circuits of claim 27 in which the electrical resistance of said piggy back light string across said connector is on the order of the electrical resistance of said incandescent light bulb, said limiting current through said string of incandescent lights.

35. The circuits of claim 27 in which multiple LED lights are electrically connected in parallel across said connector with alternating connection polarities.

36. The circuits of claim 27 in which a pair of LED lights is electrically coupled in series across said power supply connector.

37. The circuits of claim 27 in which multiple pairs of LED lights are electrically connected in parallel across said connector with alternating connection polarities, where each of said pairs of LED lights is electrically coupled in series.

38. The circuits of claim 27 in which an incandescent flasher bulb is electrically connected across the bulb socket in which said connector is engaged.

39. An LED light string having a power supply connection provision adapted to engage and draw electrical power from an empty bulb socket in an incandescent light string.

40. A circuit in which an LED light is coupled with an incandescent light bulb.

41. A circuit in which multiple LED lights are coupled with one or more incandescent bulbs in a light string.

42. A circuit in which multiple LED lights connected in parallel are electrically coupled with AC powered incandescent light bulbs in a series incandescent light string.

43. A circuit in which multiple LED lights connected in parallel are electrically coupled with DC powered incandescent light bulbs in a series incandescent light string.
